(19) United States
(12) Patent Application Publication
(10) Pub. No.: US 2015/0025568 A1
(43) Pub. Date: Jan. 22, 2015

(54) TWO-HAND ADJUSTABLE ACUPRESSURE METHOD AND APPARATUS

(71) Applicant: Amy Liu, Arcadia, CA (US)

(72) Inventor: Amy Liu, Arcadia, CA (US)

(21) Appl. No.: 13/947,957

(22) Filed: Jul. 22, 2013

(51) Int. Cl. A61H 15/00

(52) U.S. Cl. CPC A61H 15/0092; A61H 2015/0042
USPC 606/204

(57) ABSTRACT

Acupressure apparatus and method that relieves muscle knots and tightness in a user's back by means of an acupressure ball which is threaded two ends by a cord, the cord being both flexible and stretchable. The ball is adjustable along the cord and can be set at a fixed position along the length of the cord using two anchors around the holes where the ball is threaded through. The user grasps the apparatus at each end of the cord and the apparatus can be positioned at the desired spot on a user's back by any of a combination of adjusting the user's hands, arms, and the position of the ball along the cord while the user is grasping the acupressure apparatus. The user's body weight applied on the ball against a rigid surface will apply acupressure therapy.

### BACKGROUND OF THE INVENTION

1. Field of the Invention

The present invention relates generally to an external pressure applicator to provide treatment for pain or disease. Specifically, this invention is directed to a novel manually operated acupressure apparatus that can be easily adjusted to a predetermined point along a user's back for application of acupressure relief.

2. Description of the Related Art

Generally, the art and technique of acupressure is the application of pressure to certain points of the body as a way to bring about healing. As distinguished from acupuncture where pressure is given by needles, acupressure applies pressure by compressive force from some object against the body without puncturing the skin, and thus is a much less invasive approach. Moreover, acupuncture treatments require more highly trained individuals since needles are used, whereas acupressure treatments require only basic training Acupressure treatment is extremely economical and can be self administered or administered by a trained professional. The success of acupressure can be gleaned from the plethora of professional massage therapists operating around the world.

Acupressure has been found to provide a myriad of benefits. Acupressure has been found helpful in relieving arthritis, back pain, chronic pain over parts of the body, migraine headaches, among various other successful treatments. Acupressure is often viewed as an alternative treatment for areas where medication may not have been helpful, cannot help at all, or may not be the best option to take given a patient's other health issues. Acupressure also often serves as a complement to the more traditional medicine approach.

There are several acupressure pressure points on the back. Many of these pressure points are in hard to reach places and often require a professional massage therapist to accurately and effectively reach in order to apply the adequate amount of pressure. In the prior art, several devices have been developed that provide self-application of acupressure to a user's back. While they have tremendous advantages in enabling the user to practice acupressure at the user's own convenience, they have shortcomings in certain respects.

US Pat. Pub. No. 2004/0193081 to Sils discloses using a ball to apply pressure to a user's back. However, the positioning of the ball in Sils to a specific pressure point on the user's back is cumbersome, requiring guiding of the ball by the person's body, while the person's back is on the ball and the rigid surface. U.S. Pat. No. 5,779,652 to Mencher-Aliazzo discloses a series of balls in which a series of strings are threaded through. The balls can be laid out in a predetermined pattern on a rigid surface based on where the pressure points are. The user then positions him or her according to the pattern on the rigid surface. This approach is also cumbersome and the device complicated, requiring a longer and more complicated setup of the pattern the threaded balls will take, necessitating attachment of the balls to the rigid surface, and an overall less compact device for transport and mobility. U.S. Pat. No. 8,292,915 to Akcasu discloses and acupressure device that is held by a single hand. While the device is compact, it has a rigid handle bar and in some circumstances, cannot be fit into tight spaces such as a gym bag. Furthermore, when in use, the rigid handle bar may sometimes be pressed against the wall by the user's back, and thus may be irritate or cause pain to the user's back. Lastly, position of the ball at the precise point may be more difficult than by a device with two hands and once the ball is in place, the ability of the ball to stay in that position may be more difficult than by another device whose acupressure ball is supported by two hands. U.S. Pat. No. 5,730,708 to Spratt discloses an acupressure back device that is held by two hands and can be manipulated to different pressure points on the back. However, the device is complex, having many parts, and requiring substantial assembly. Furthermore, the entire body of the device is rigid, and thus making the device difficult to transport.

There is a need for a simple acupressure device that gives the user the ability to easily carry the device around, quickly and accurately place the device to a desired pressure point, and reliably keep and maintain the acupressure in that position during self-application.

### SUMMARY OF INVENTION

It is the object of this invention to provide means to self-administer acupressure without the deficiencies found in the prior art.

Accordingly, in an embodiment of the present invention, an acupressure apparatus easily positions an acupressure ball on a user's back by flexible handles provided on each end of a flexible and elastic cord, the cord being threaded through the acupressure ball. One innovative aspect of the invention is the acupressure apparatus in its entirety is flexible and compact, allowing storage in tight places as well as being light and easy to transport where ever the user travels. Another innovative aspect of the invention is the acupressure ball can be shifted and then fixed to any location along the length of the cord. This gives the user additional latitude to more easily position the acupressure ball at the precise pressure point. Once the user has the ball positioned in the correct location, the user can lean on the ball and onto a rigid object, such as a wall, and be able to easily maintain the ball in that position against the rigid object by continuing to hold onto the handles. Pressure is applied to the pressure point of the body by the force of the body against the ball and wall. Any rotations to the ball made by the user's body can further apply pressure to the surrounding pressure point area. In another innovative aspect of the invention, upon positioning the acupressure ball in the precise position on the user's back and the subsequently leaning on the ball onto the wall, the handles can be released giving the user's hands and arms freedom of movement. The acupressure ball will apply pressure without any interference or irritation from a hard object, since the entire acupressure apparatus if flexible. This will further allow the user's arms to rest freely.

The details of one or more embodiments are set forth in the accompanying drawings and detailed description below. Other features, objects, and advantages of the invention will be apparent from the drawings and description.

### BRIEF DESCRIPTION OF THE DRAWINGS

FIG. 1A is an illustrative representation of the exemplary acupressure apparatus.

FIG. 1B is an illustrative representation of the acupressure ball being able to be adjusted along the flexible and elastic cord.

FIG. 2A is an illustrative representation from a frontal view of a user using the acupressure apparatus.

FIG. 2B is an illustrative representation from a rear view of a user using the acupressure apparatus.

FIG. 3 is an example chart of acupressure points the acupressure apparatus can be applied on.

FIG. 4 is an illustrative representation of a user applying pressure on an acupressure point against a rigid surface with the flexible handles of the acupressure apparatus released.

FIG. 5 an is illustrative representation of a user applying pressure on an acupressure point against a rigid surface while still holding onto the flexible handles of the acupressure apparatus.

### DETAILED DESCRIPTION OF THE INVENTION

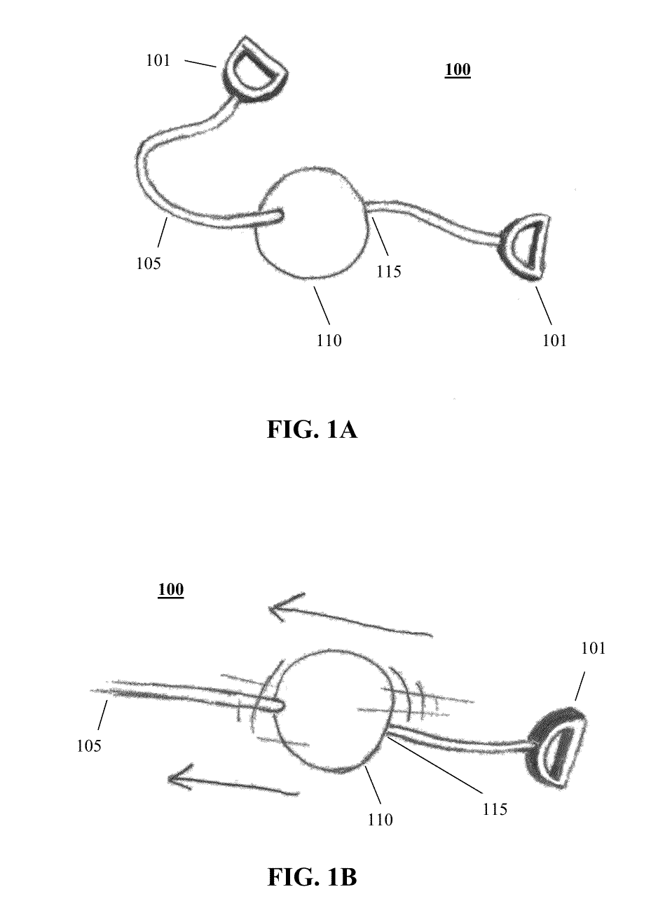

FIG. 1A shows an exemplary acupressure apparatus 100. The entirety of the acupressure apparatus 101 is flexible, elastic and stretchable. A cord 105 is threaded through an acupressure ball 110. At each end of the cord 105, flexible handles 101, allow a user grasp the acupressure apparatus 100. Material composition for the elastic cord 105 and handles 101 can be rubber or another durable and stretchable polymer substitute. The total length of the elastic cord 105 and handle 101 can accommodate the length and height of a majority of users, further aided the ability to stretch. The acupressure ball 110 is a semi-rigid spheroid made of hard rubber or a polymer substitute. Various sizes of acupressure balls can be used and threaded through with the cord 105. This is one of the key advantages of the invention is different size acupressure balls with differing amount of applied pressure can be used based on size, customizing the user's acupressure experience. Once the cord 105 is threaded through the ball 110, the ball 110 can be set in place by either the friction of the contact between the ball 110 and cord 115, or by physical stoppers at the points where the cord 105 exit and enter the ball 110.

FIG. 1B demonstrates a key advantage of the acupressure apparatus 100. FIG. 1B shows an example of the acupressure ball 110 being adjusted in one particular direction. The user is able to adjust of the ball 110 along the length of the cord 105 so as to position the ball in the precise location along the users back at the desired pressure point.

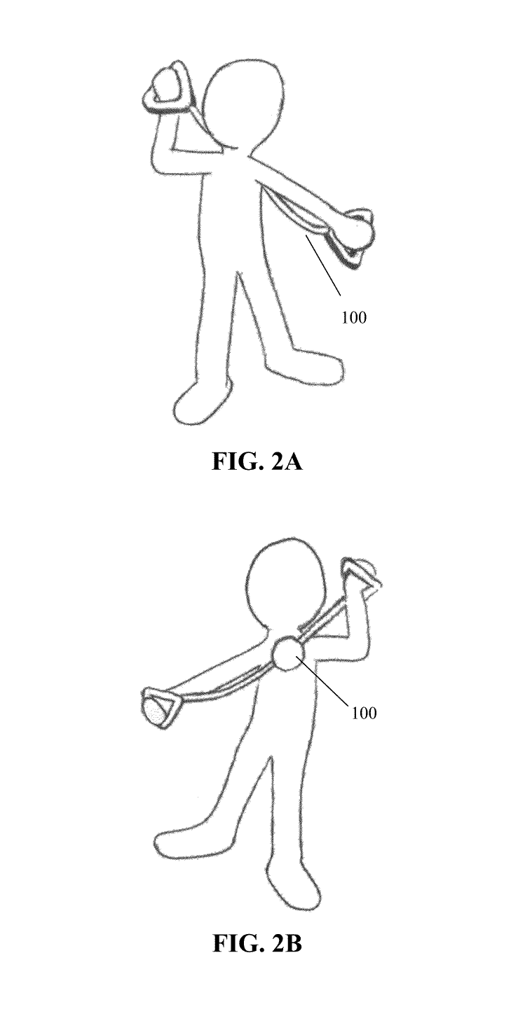

FIG. 2A is a front perspective view of a user adjusting the acupressure apparatus 100 to the desired pressure point along the user's back. The user grips the flexible handles and can guide the acupressure ball to the desired pressure point.

FIG. 2B is a rear perspective view of a user adjusting the acupressure apparatus 100 to the desired pressure point along the user's back. The user grips the flexible handles and can guide the acupressure ball to the desired pressure point.

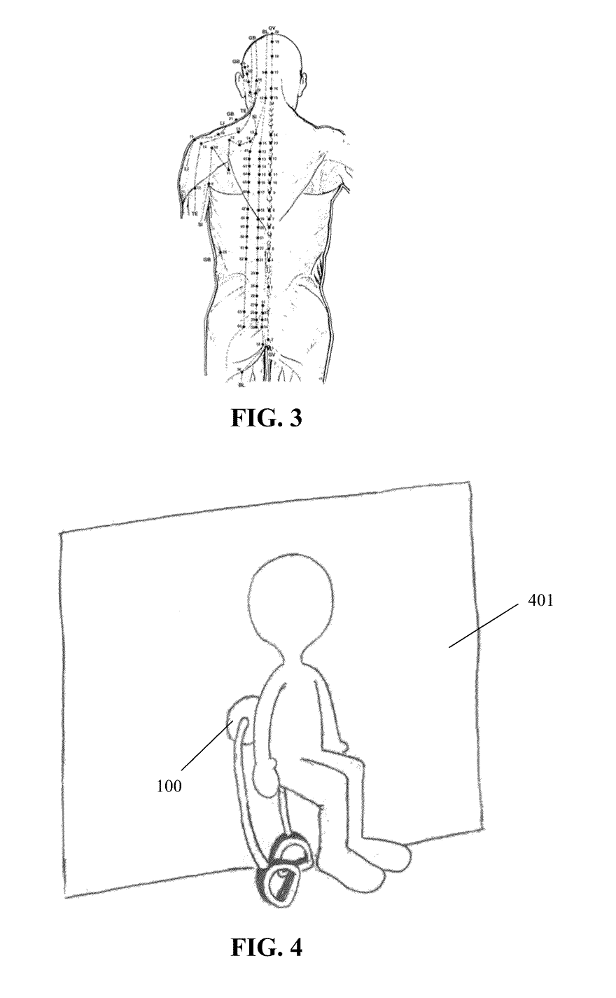

FIG. 3 shows a sample chart of the different acupressure points along a human user's back. The acupressure apparatus 100 can be positioned by the user to apply pressure at these points for healing.

FIG. 4 shows a method in which a user leans against the acupressure apparatus 100 and a rigid surface 401, so as to induce sufficient pressure at the desired pressure point. The acupressure ball has already been positioned at the desired location of the pressure point, as demonstrated in FIGS. 2A and 2B, and the user has subsequently leaned with the acupressure ball being on the acupressure point, onto the rigid surface 401. In the particular embodiment shown in FIG. 4, the user has released the handles which allow the users arms to hang freely along the user's side. This enables the user to apply and concentrate more force onto the pressure point by being able to lean harder against the acupressure apparatus 100 and the rigid surface 401.

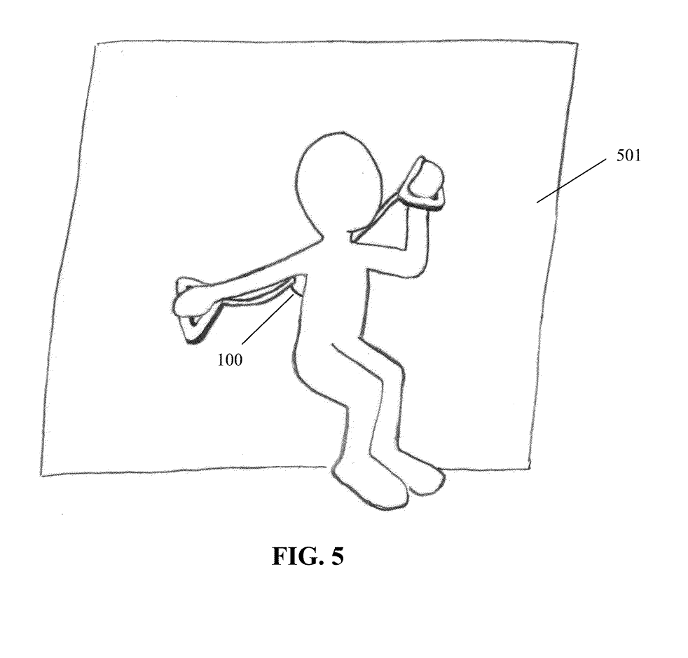

FIG. 5 shows another exemplary embodiment similar to that shown in FIG. 4, however here, the user is holding onto the handles 101 in the manner shown in FIG. 2A and FIG. 2B, while leaning against the rigid surface 501. The advantage here is to give the user the ability to adjust the acupressure apparatus to various desired pressure points in quick succession.

It should be further understood that the drawings, mode of operation and description of the invention are demonstrative and explanatory, and that variations in structure and procedure may be made without departing from the spirit the invention and the scope of the claimed invention.

1. An apparatus for applying acupressure to targeted pressure points on a human user's back, the apparatus comprising:
an elastic cord stretchable by the human user;
a first handle attached to one end of the elastic cord;
a second handle attached to the opposite end of the elastic cord;
a first ball that is threaded through by the elastic cord, through the entire diameter of the ball.

2. The apparatus of claim 1, wherein said first handle and said second handle are made of the same material as said elastic cord.

3. The apparatus of claim 2, wherein said first handle and said second handle has sufficient flexibility and stretchability to thread and unthread through said ball along with said elastic cord.

4. The apparatus of claim 1, wherein said first handle and said second handle are made of different material as said elastic cord.

5. The apparatus of claim 1, wherein said ball is fixed in place to said elastic cord at a predetermined position on the elastic cord by friction between surfaces where said elastic cord and said ball make contact.

6. The apparatus of claim 1, wherein said ball is fixed in place to said elastic cord at a predetermined position on said elastic cord by a first stopper and a second stopper, said first stopper is wedged into where said elastic cord makes entry into the ball and said second stopper is wedged into where said elastic cord exits said ball.

7. The apparatus of claim 2, wherein said first stopper can be unwedged from where said elastic cord makes entry into said ball and said second stopper can be unwedged from where said elastic cord exits said ball.

8. The apparatus of claim 1, wherein said first ball is replaced with a second ball of different size and applicable pressure from said first ball.

9. The apparatus of claim 1, wherein said ball is permanently fixed into place on said elastic cord.

10. A method for applying acupressure on a user's back using an acupressure apparatus comprised of a cord, a ball threaded through by said cord, a first and second handle attached to respective ends of said cord, the method comprising the steps of:
the user choosing a first acupressure point on said user's back;
the user grasping the acupressure apparatus by said first handle and said second handle;
the user positioning said acupressure apparatus along the user's back until said ball is directly over the first acupressure point.
apply pressure to the first acupressure point using the said acupressure apparatus.

11. The method of claim 10, wherein the step of applying pressure further comprises the user pulling on said first handle and said second handle and inducing a first desired pressure by said ball from the amount of said pulling, to cause healing from said first acupressure point.

12. The method of claim 10, wherein the step of applying pressure further comprises the user leaning said ball against a rigid surface and inducing a desired pressure by said ball from the amount of said leaning, to cause healing from said acupressure point.

13. The method of claim 12, further comprising the step of releasing said first handle and said second handle once the user is leaning onto said rigid surface in order to induce even more force onto said first acupressure point than if said first handle and said second handle were not released.

14. The method of claim 13, further comprising the step of the user applies a circular motion onto said ball to induce healing from a larger area around said acupressure point.

15. The method of claim 11, further comprising the step of: after the first desired pressure is applied to said first acupressure point, a second acupressure point is chosen and the user repositions said acupressure apparatus along the user's back to said second acupressure point to apply a second desired pressure.

16. The method of claim 15, wherein the first desired pressure and the second desired pressure are the same.

17. The method of claim 15, wherein the first desired pressure and the second desired pressure are different.

18. The method of claim 10, further comprising the steps of:
removing the ball from the acupressure apparatus by unthreading the ball from said cord and either said first handle or said second handle;
rethreading a different ball, through either said first handle or said second handle;
sliding said different ball to a desired location along the length of said cord.

19. The method of claim 10, further comprising the step of sliding said ball to a desired location along the length of said cord and fixing the ball along the length of said cord by wedging a first stopper and a second stopper where said cord makes entry into the ball and where said cord exits said ball.

20. The method of claim 18 or 19, further comprising the step of fixing the ball along the length of said cord by wedging a first stopper and a second stopper where said cord makes entry into the ball and where said cord exits said ball.
